(19) United States
(12) Patent Application Publication
(10) Pub. No.: US 2021/0331007 A1
(43) Pub. Date: Oct. 28, 2021

(54) FILTER CARTRIDGE AND METHODS OF MAKING AND USING

(71) Applicant: W. L. Gore & Associates, Inc., Newark, DE (US)

(72) Inventors: Kevin J. Cresswell, Flagstaff, AZ (US); Nathan L. Friedman, Flagstaff, AZ (US); Justin W. Sokel, Flagstaff, AZ (US)

(21) Appl. No.: 17/241,962

(22) Filed: Apr. 27, 2021

Related U.S. Application Data
(60) Provisional application No. 63/015,947, filed on Apr. 27, 2020.

(51) Int. Cl. A62B 23/02; A62B 7/10; A62B 18/08

(52) U.S. Cl. CPC A62B 23/02; A62B 18/08; A62B 7/10

(57) ABSTRACT

A filter cartridge includes a first end component, a second end component, and filter media positioned between the first end component and the second end component is provided. The filter media maintains separation between the first end component and the second end component to allow for air flow through the filter media. The first end component includes at least two receptors and the second end component includes at least one protrusion configured to interface with the at least two receptors to hold the first end component and the second end component in the same relative position with respect to each other when a torque is applied to the filter cartridge. The cartridge is assembled together by adhesive binding the filter media to the first end component and the second end component.

### FIELD

The present invention relates to filter cartridges that can be used on filtration masks, powered air purification devices (PAPD), ventilators, and in other filter applications, and methods for manufacturing and using the same.

### BACKGROUND

Filters are used in a variety of settings including those with hazardous conditions including at work sites. Personal air filter systems are implemented to protect the respiratory system of an individual and may be worn directly or indirectly in contact with the user's respiratory system. The present invention rectifies deficiencies presently not addressed in the art.

### SUMMARY

Various aspects relate to a filter cartridge that permits simple attachment to a wide variety of essential healthcare devices which effectively protects its filter media from accidental damage and allows for cleaning and resterilization. The filter cartridge may be adapted for use in N95 (NIOSH) facemasks and other filtration devices.

According to one example (“Example 1”), a filter cartridge includes a first end component, a second end component, and filter media positioned between the first end component and the second end component, the filter media maintaining separation between the first end component and the second end component to allow for air flow through the filter media. The first end component optionally includes at least two receptors with the second end component including at least one protrusion configured to interface with the at least two receptors to hold the first end component and the second end component in the same relative position with respect to each other when a torque is applied to the filter cartridge. The filter cartridge is optionally assembled together by adhesive binding the filter media to the first end component and the second end component.

According to another example (“Example 2”), further to Example 1, the first end component includes at least 3 slots and the second end component includes at least 3 corresponding protrusions.

According to another example (“Example 3”), further to Example 1, the first end component and the second end component include a series of projections that partially cover the filter media to protect the filter media from damage when the filter cartridge is handled.

According to another example (“Example 4”), further to Example 3, the projections comprise an undulating pattern.

According to another example (“Example 5”), further to Example 1, the cartridge is assembled together with only the adhesive binding the filter media to the first end component and the second end component.

According to another example (“Example 6”), further to Example 1, a fitting is included on at least one of the end components to allow the filter cartridge to be attached onto a base.

According to another example (“Example 7”), further to Example 6, the fitting is configured to allow the filter cartridge to be attached to the base by twisting.

According to another example (“Example 8”), further to Example 1, the base comprises a facemask.

According to another example (“Example 9”), further to Example 1, the base comprises an interface with a hose.

According to another example (“Example 10”), further to Example 9, the hose attaches to a powered air purification device.

According to another example (“Example 11”), further to Example 9, the hose attaches to a ventilator device.

According to another example (“Example 12”), further to Example 1, the base comprises an interface with a flat plate with a cutout.

According to another example (“Example 13”), further to Example 6, the end component with the fitting includes a gasket interface.

According to another example (“Example 14”), further to Example 13, the gasket interface comprises a groove configured to receive an O-ring gasket to seal between the filter cartridge and the base.

According to another example (“Example 15”), further to Example 13, the gasket interface comprises a circular flat gasket attached to the end component.

According to another example (“Example 16”), a filter cartridge that includes a first end component, a second end component, and filter media positioned between the first end component and the second end component, the filter media maintaining separation between the first end component and the second end component to allow for air flow through the filter media; wherein the first end component and the second end component include a series of projections that partially cover the filter media to protect the filter media from damage when the filter cartridge is handled.

According to another example (“Example 17”), further to Example 16, the projections comprise an undulating pattern.

According to another example (“Example 18”), further to Example 16, the first end component includes at least two slots and the second end component includes at least one protrusion configured to interface with the at least two slots to hold the first end component and the second end component in the same relative position with respect to each other when a torque is applied to the filter cartridge.

According to another example (“Example 19”), further to Example 18, the first end component includes at least 3 slots and the second end component includes at least 3 corresponding protrusions.

According to another example (“Example 20”), further to Example 16, a fitting is included on at least one of the end components to allow the filter cartridge to be attached onto a base.

According to another example (“Example 21”), further to Example 20, the base comprises a facemask.

According to another example (“Example 22”), a filter cartridge including a first end component, a second end component, and filter media positioned between the first end component and the second end component, the filter media maintaining separation between the first end component and the second end component to allow for air flow through the filter media; wherein the first end component includes at least one protrusion configured to interface with second end component to resist compression of the first end component towards the second end component other during use; wherein the cartridge is assembled together by adhesive binding the filter media to the first end component and the second end component.

According to another example (“Example 23”), a filter cartridge for mounting to a facemask, the filter cartridge includes a first end component having a first diameter; a second end component having a second end diameter that is greater than the first diameter; and a filter media positioned between the first end component and the second end component, the filter media maintaining separation between the first end component and the second end component to allow for air flow through the filter media, the filter media having a tapered outer profile from the first end component toward the second end component.

According to another example (“Example 24”), further to Example 23, the first end component includes at least two receptors and the second end component includes at least one protrusion configured to interface with the at least two receptors to hold the first end component and the second end component in the same relative position with respect to each other when a torque is applied to the filter cartridge.

According to another example (“Example 25”), further to Example 23, the first end component includes at least 3 slots and the second end component includes at least 3 corresponding protrusions.

According to another example (“Example 26”), further to Example 23, wherein the first end component and the second end component include a series of projections that partially cover the filter media to protect the filter media from damage when the filter cartridge is handled.

According to another example (“Example 27”), further to Example 26, the projections comprise an undulating pattern.

According to another example (“Example 28”), further to Example 23, the cartridge is assembled together with only the adhesive binding the filter media to the first end component and the second end component.

According to another example (“Example 29”), further to Example 23, a fitting is included on at least one of the end components to allow the filter cartridge to be attached onto a base.

According to another example (“Example 30”), further to Example 29, the fitting is configured to allow the filter cartridge to be attached to the base by twisting.

According to another example (“Example 31”), further to Example 23, the base comprises a facemask.

According to another example (“Example 32”), further to Example 23, the base comprises an interface with a hose.

According to another example (“Example 33”), further to Example 32, the hose attaches to a powered air purification device.

According to another example (“Example 34”), further to Example 32, the hose attaches to a ventilator device.

According to another example (“Example 35”), further to Example 1, the base comprises an interface with a flat plate with a cutout.

According to another example (“Example 36”), further to Example 29, the end component with the fitting includes a gasket interface.

According to another example (“Example 37”), further to Example 36, the gasket interface comprises a groove configured to receive an O-ring gasket to seal between the filter cartridge and the base.

According to another example (“Example 38”), further to Example 36, the gasket interface comprises a circular flat gasket attached to the end component.

### BRIEF DESCRIPTION OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 is a top pan view of one embodiment of a filter cartridge.

FIG. 2 is a cross-section view of one embodiment of a filter cartridge taken along line A-A in FIG. 5.

FIG. 3 is a three-quarter isometric view of one embodiment of a filter cartridge, illustrating its second end component and bayonet attachment.

FIG. 4 is a side view of one embodiment of a filter cartridge.

FIG. 5 is a side view of the embodiment of the filter cartridge of FIG. 4 rotated 90 degrees.

FIG. 6 is a cross-section view of one embodiment of a filter cartridge taken along line B-B in FIG. 5.

FIG. 7 is a plan bottom view of one embodiment of a filter cartridge.

FIG. 8 is a three-quarter isometric view of one embodiment of a filter cartridge, illustrating its first second end component.

FIG. 9 is an exploded view of the isometric view of the filter cartridge illustrated in FIG. 8.

FIG. 10 is an exploded view of the isometric view of the filter cartridge illustrated in FIG. 3.

FIG. 11 is a partial cut-away of the exploded view of the filter cartridge illustrated in FIG. 9.

FIG. 12 is a partial cut-away of the exploded view of the filter cartridge illustrated in FIG. 10.

FIG. 13 is an exploded view of the filter cartridge illustrated in FIG. 9 shown in relation with an O-ring and facemask.

FIG. 14 is an exploded view of the filter cartridge illustrated in FIG. 10 shown in relation with an O-ring and facemask.

FIG. 15 is a front view of one embodiment of a filter cartridge shown mounted on a facemask.

FIG. 16 is a cross-section view of the filter cartridge and facemask of FIG. 15 taken along line C-C.

FIG. 17 is an exploded view of the filter cartridge illustrated in FIG. 9 shown in relation with an O-ring and a base plate.

FIG. 18 is an exploded view of the filter cartridge illustrated in FIG. 10 shown in relation with an O-ring and base plate.

FIG. 19 is a top plan view of one embodiment of a filter cartridge mounted to an O-ring and base plate.

FIG. 20 is a cross-section view of the filter cartridge of FIG. 20, taken along line D-D.

FIG. 21 is an exploded view of the filter cartridge illustrated in FIG. 9 shown in relation with a gasket and a base plate.

FIG. 22 is an exploded view of the filter cartridge illustrated in FIG. 10 shown in relation with a gasket and a base plate.

FIG. 23 is a top plan view of one embodiment of a filter cartridge mounted to a gasket and base plate.

FIG. 24 is a cross-section view of the filter cartridge of FIG. 23, taken along line E-E.

FIG. 25 is a front view of a person wearing a powered air purification device incorporating one embodiment of a filter cartridge.

FIG. 26 is a front view of a person wearing a facemask incorporating one embodiment of a filter cartridge.

FIG. 27 is a side view of a person wearing a facemask incorporating one embodiment of a filter cartridge.

FIG. 28 is a plan view of a facemask and O-ring, and one embodiment of a detached filter cartridge arranged side-by-side.

FIG. 29 is a side view of an embodiment of a base attachment mounted on a hose.

FIG. 30 is a three-quarter view of the base attachment and hose illustrated in FIG. 29.

FIG. 31 is a side view of the base attachment and hose illustrated in FIG. 29 with an embodiment of a filter cartridge mounted to the base.

FIG. 32A is a front view of a tapered filter cartridge incorporating one embodiment of a filter cartridge.

FIG. 32B is a side view the filter cartridge illustrated in FIG. 32A.

FIG. 33 is a side view of a tapered filter cartridge with projections extending from the end components incorporating one embodiment of a filter cartridge.

### DETAILED DESCRIPTION OF THE ILLUSTRATED EMBODIMENTS

Persons skilled in the art will readily appreciate that various aspects of the present invention may be realized by any number of methods and apparatuses configured to perform the intended functions. Stated differently, other methods and apparatuses may be incorporated herein to perform the intended functions. It should also be noted that the accompanying drawing figures referred to herein are not all drawn to scale, but may be exaggerated to illustrate various aspects of the present invention, and in that regard, the drawing figures should not be construed as limiting.

Although the present invention may be described in connection with various principles and beliefs, the present invention should not be bound by theory.

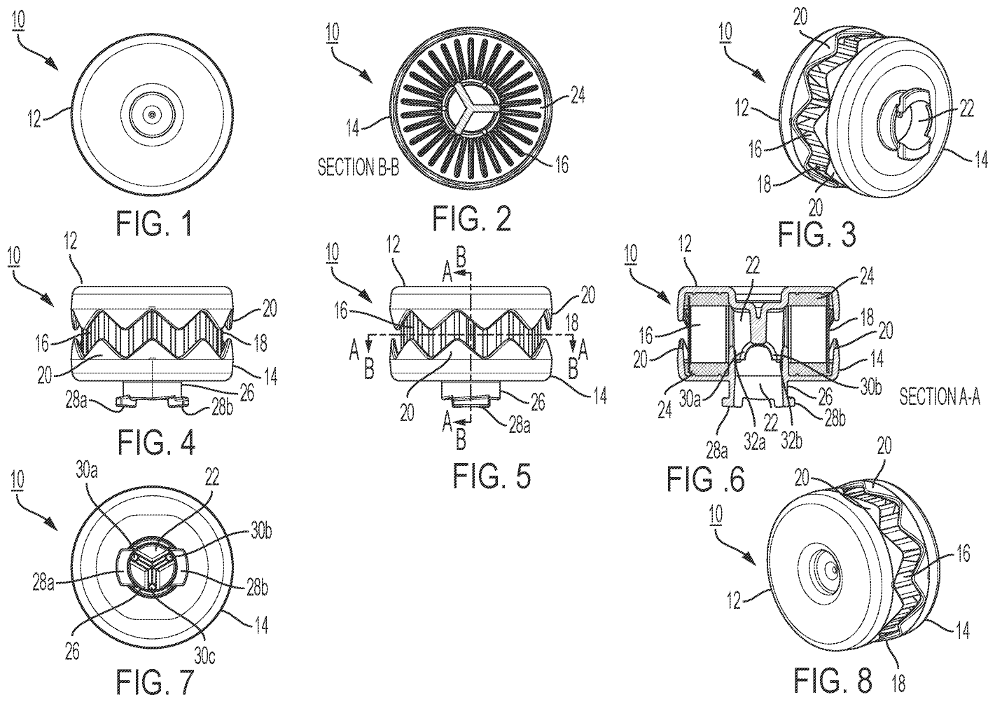

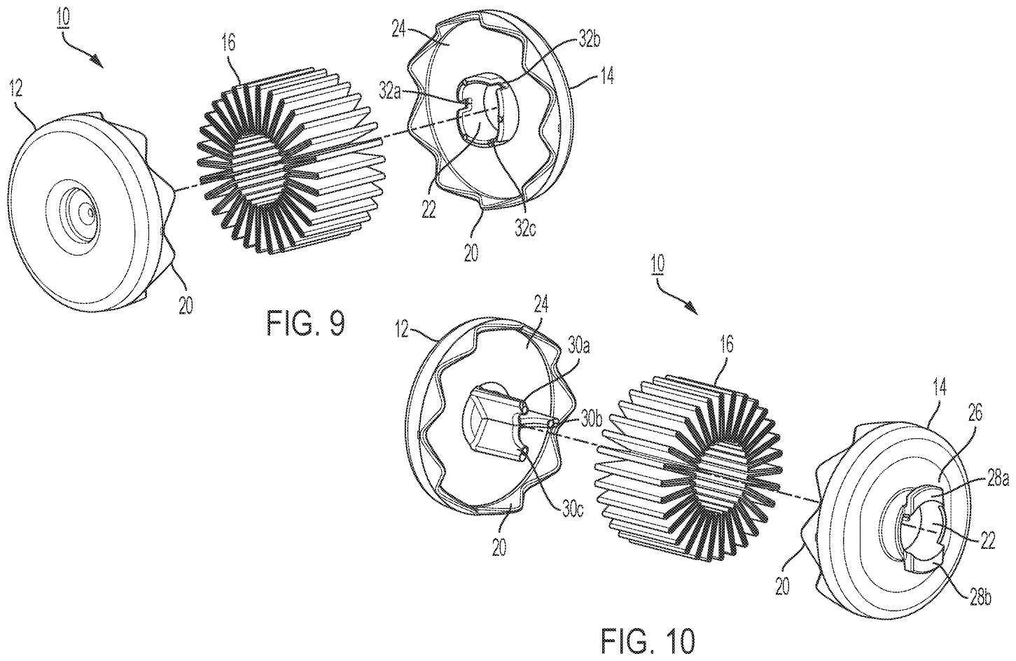

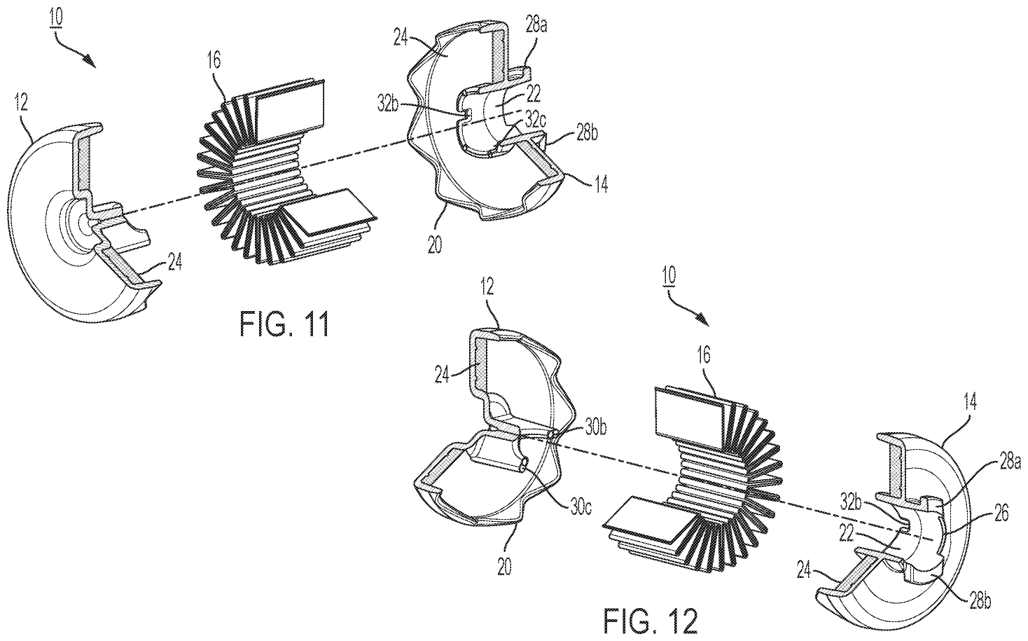

Shown in FIGS. 1 through 12 is one embodiment of a filter cartridge 10 as disclosed herein. The filter cartridge comprises first and second end components, such as top end component 12 and bottom end component 14, and a filter media 16 mounted between the two end components. A gap 18 is provided between the two end components of sufficient dimensions to allow free airflow through the filter media.

The filter media 16 may be of any desirable material and construction. Filter material may comprise a plastic, paper, or other material, and may be a membrane, laminate, felt, or any other suitable construction. For use in a filter cartridge 10 that is designed to be washed, sterilized, disinfected, or otherwise cleaned and restored, the filter material should be one that will withstand the restoration demands. Suitable filter materials include expanded polytetrafluoroethylene (ePTFE), polyethylene (PE), polypropylene, or other filter materials now known or other developed. The filter media may be arranged in any desired configuration, for example in a cylinder or various convoluted shapes. Shown in the Figures, the filter media contains multiple pleats which increases the surface area of the filter material. The filter media can be coated, loaded, layered, other otherwise combined with other materials, such as antimicrobials, carbon, etc. to increase filter effectiveness or operative life. For use in a N95 type filter applications, it is desirable to use a filter material such as polyester, polypropylene, polyurethane, activated carbon, ePTFE, nylon, or cellulose.

Similarly, the end components 12, 14 may be constructed of any suitable material for the desired application, such as employing plastic, metal, carbon, or other materials that can be machined, shaped, injection molded or otherwise molded, layered, 3D printed, vacuum formed, or otherwise created. Again, if it is desirable to wash, sterilize, disinfect, or otherwise clean or restore the filter cartridge, the end components should be constructed from a material that will withstand the desired restoration processes. For use in a N95 type filter applications, it is desirable to construct the end components from a plastic material, such as polycarbonate, polysulfone, nylon, or stainless steel.

One or both of the top end component 12 and bottom end component 14 may include a series of projections 20 that partially cover and protect the filter media 16 while still maintaining the gap 18. The projections may be of any suitable size, shape, or dimensions to avoid unintentional handling of the filter media when the filter cartridge 10 is manipulated. A suitable gap 18 may be approximately the size of a user's finger, e.g., approximately 0.5, 1, 1.5, 2, 2.5, 3, 3.5, or 4 cm (0.20, 0.39, 0.59, 0.79, 0.98, 1.18, 1.38, and 1.57 inches, respectively), so that a user does not accidentally reach through the gap and damage the filter media during use. Regardless of the size of the gap, the projections 20 also provide a suitable surface against which a user may grip the filter cartridge without contacting the filter media 16.

In the embodiment shown, the projections 20 are configured as a series of undulations and the undulations on the top end component 12 and the bottom end component 14 are oriented in cooperation with each other to form an evenly spaced gap 18 around the circumference of the filter cartridge 10. While the use of uniform, cooperating undulations provides an appealing ornamental presentation, it should be understood that the projections may be shaped and aligned in a variety of ways to provide effective protection of the filter media 16, including as square or other rectangular shapes, semi-circular or other oval shapes, diamond or other triangular shapes, fingers or other elongated projections, etc. as well as any of a variety of irregular shapes. The projections may or may not be aligned to cooperate between the end components to form an even gap 18 around the circumference of the filter cartridge 10. The projections 20, for example, provide increased surface are on one of the top end component 12 or the bottom end component 14 at a circumferential position, which provides enhanced traction for manipulation. By including cooperating projections 20, increased surface area is provided at various circumferential positions on both the top end component 12 and the bottom end component 14 as one or both may need to be adjusted, manipulate, or otherwise handled.

An air channel 22 is provided through the bottom end component 14 to provide air communication between the gap 18, through the filter media 16, and through the air channel 22.

To assemble the filter cartridge 10 together, the filter media 16 is bonded or otherwise attached to each of the end components. The attachment of the filter media 16 and the end components may be a fluid-tight or near fluid-tight connection (that is, resistant to both gas and liquid fluids) so as to restrict or avoid fluid flow around the filter media 16. It should be understood, however, that for purposes of achieving the intended results of this description, the attachment need only be sufficient to resist passage of particles or other substances that are sought to be filtered. The attachment may be of any suitable form between the filter media 16 and the end component, such as using an adhesive, potting material, thermal, ultrasonic or other forms bonding, etc. The end components may include a groove to receive the filter media 16 to form a more secure and uniform connection.

In the one embodiment shown in the Figures, such as shown in FIGS. 2, 6, 9-12, the filter media 16 is attached to the end components by applying an adhesive 24 in the form as potting material in each of the end components into which the filter media 16 is embedded and bonded. The potting material may be any form of material that will form a strong, fluid-tight bond with the filter media 16. Suitable materials may be a polymer such as a thermoplastic or thermoset material, such as polyurethane, silicone, epoxy resins, cyanoacrylate, and other acrylic adhesives, etc.

The bottom end component 14 is configured to attach to a variety of bases in a fluid-tight manner to allow the filter cartridge 10 to be in direct or indirect fluid communication with a user's respiratory system or other air transfer or collection apparatus. Suitable base attachment mechanisms may be a variety of locking mechanisms, which may include in bayonet-type twist connection, a threaded connection, a snap-in connection, a lock-ring connection, etc. The filter cartridge 10 may also be permanently or semi-permanently attached to a base, such as by adhesive or other bonding or by integrally forming the base and filter cartridge 10 together.

In the one embodiment shown, the bottom end connection 14 includes a bayonet-type twist interface 26, which included two lobes 28a, 28b configured to connect to a corresponding opening in a base.

In the one embodiment shown, the end components are attached to the filter media 16 only by means of the adhesive 24. This is an efficient method of assembling the filter cartridge together as it only requires bonding of the three components and no other attachment steps or mechanisms. One concern when assembling a filter cartridge 10 together in this manner is that any torque force applied to the top end component 12, such as by installing or removing the filter cartridge 10, will translate through the filter media 16 to the bottom end component 14. Excessive torque force may damage the filter media and/or the bond between the filter media 16 and the end components. As such, it may be desirable to include some means to assist in keeping the two end components 12, 14, and filter media 16 aligned when a torque force is applied to the filter cartridge 10.

In one embodiment shown, the two end components include cooperative elements that interlock to help all of the component parts of the filter cartridge 10 remain aligned when torque is applied, for instance by providing at least two protrusions and at least two corresponding openings in the end components. As is shown in the Figures, the top end component 12 includes at three protrusions 30a, 30b, 30c and the bottom end component 14 includes three corresponding slots or receptors 32a, 32b, 32c into which the protrusions 30 interlock. The use of this tri-lobe core construct of protrusions and receptors in this manner assists in translation of torque force through the filter cartridge 10 and assures that the filter media 16 does not experience all of the torque force. It should be understood that a similar result may be achieved with other embodiments, such as by providing a single wide or multiple-branched protrusion that interfaces with two or more complementary receptors.

The three protrusions 30a, 30b, and 30c may be positioned such that they extend through the interior of the filter media 16. For example, the protrusions 30 may extend from the top end component 12, through the internal cavity or passage formed by the filter media 16, and to the bottom end component 14. The protrusions 30 may act as a radial support to the filter media 16 when the cartridge is assembled. By providing at least one protrusion and corresponding opening in the end components, the filter cartridge 10 is provided with increase columnar strength that will decrease the likelihood that the filter media 16 will be crushed or otherwise damaged in the event that compressive strain is applied between the end components. This benefit is simultaneously achieved by providing the tri-lobe core described above.

As has been noted, the filter cartridge 10 as described may be used in conjunction with a variety of different apparatus, including facemasks, respirators, air purification systems, etc.

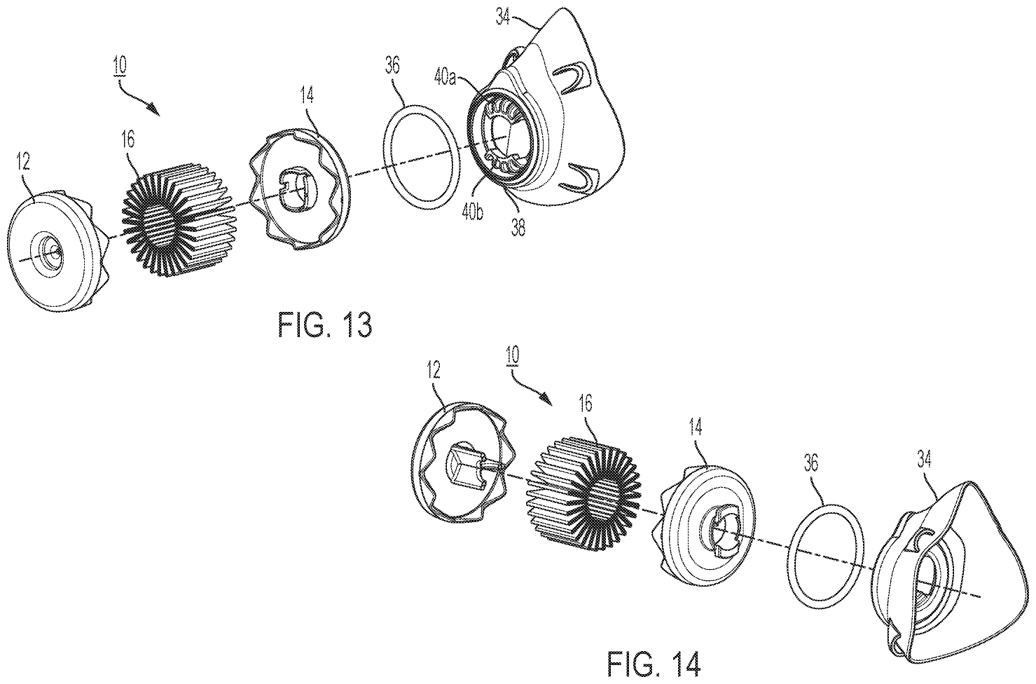

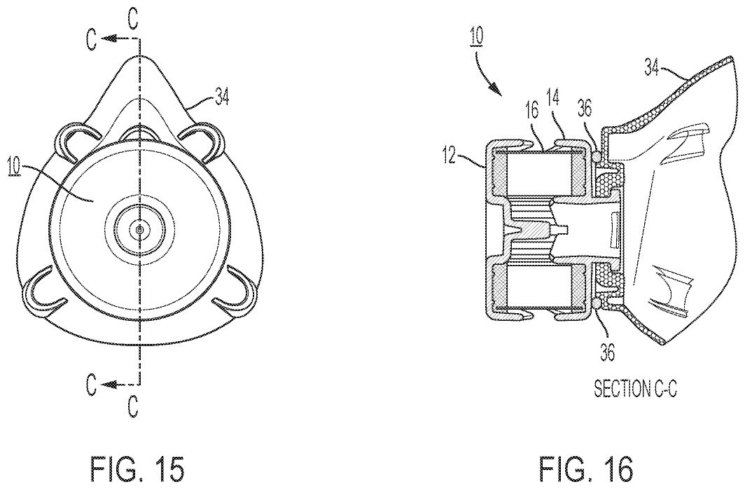

FIGS. 13-16 illustrate one embodiment of the filter cartridge 10 mounted to a base, such as facemask 34. A gasket 36 may be included between the filter cartridge 10 and the base. The gasket may be of any form that will assist in maintaining a fluid tight seal between the filter cartridge 10 and the base. A groove or other suitable junction 38 may be provided in the filter cartridge and/or the base to aid in positioning the gasket 36 and holding it in position. As shown in FIGS. 13-16, one suitable gasket may be an O-ring.

The facemask 34 includes means complementary to the interface 26 in the filter cartridge 10 to allow for a locking interface between the filter cartridge 10 and the facemask 34. In the one embodiment shown in the Figures, this comprises lobes 40a, 40b that are configured to form a locking engagement with the lobes 28a, 28b.

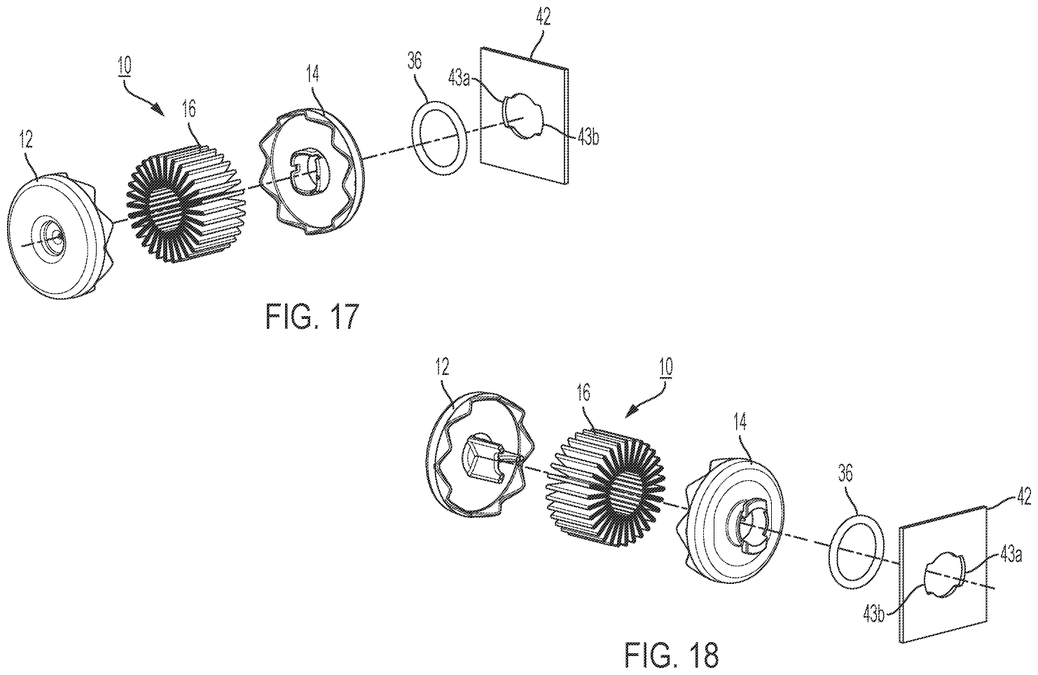

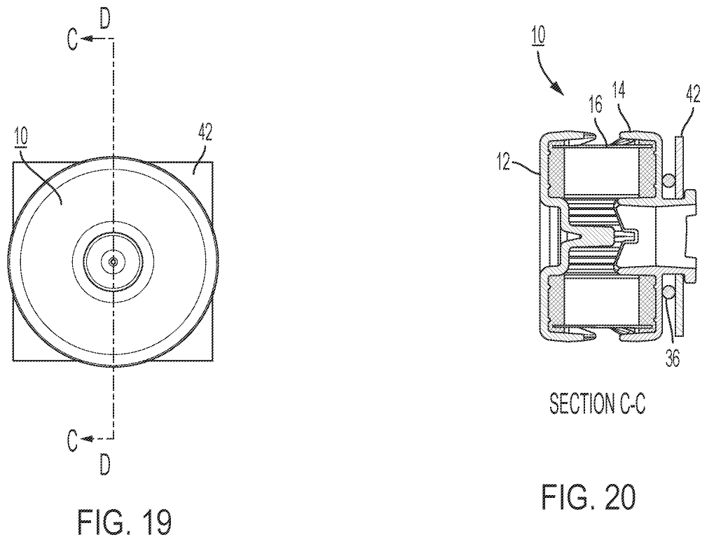

Similarly, FIGS. 17-20 illustrate one embodiment of the filter cartridge 10 mounted to a base plate 42. A gasket 36, such as an O-ring, is again included between the filter cartridge 10 and the base plate 42. The base plate 42 includes means complementary to the interface 26 in the filter cartridge 10 to allow for a locking interface between the filter cartridge 10 and the base plate 42, such as a openings 43a, 43b that are configured to receive the lobes 28a, 28b in the filter cartridge 10 and then upon twisting form a locking engagement between the filter cartridge 10 and the base plate 42.

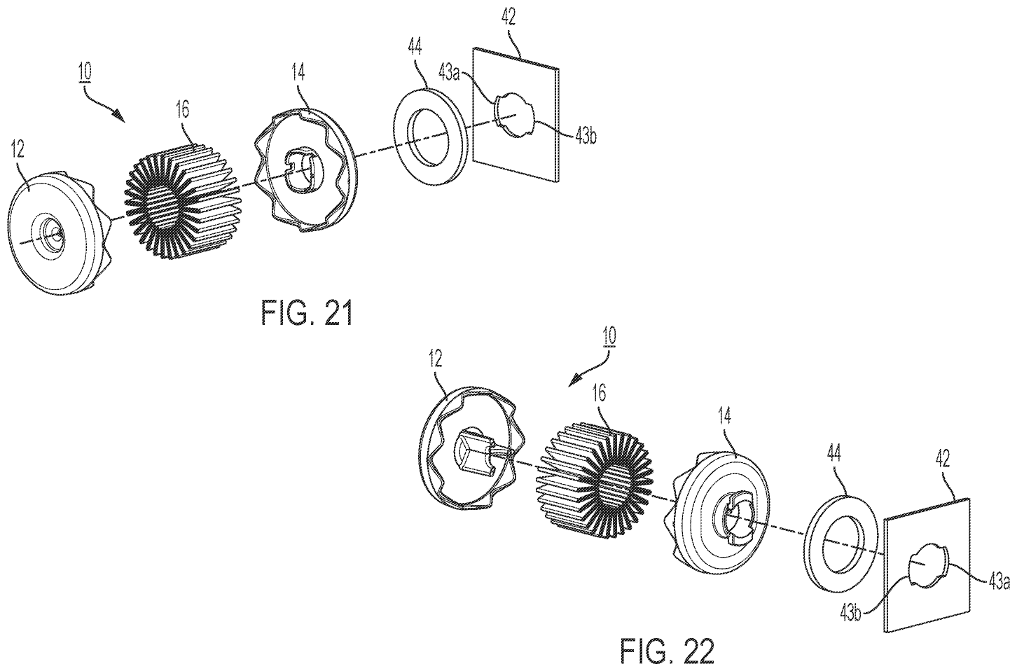

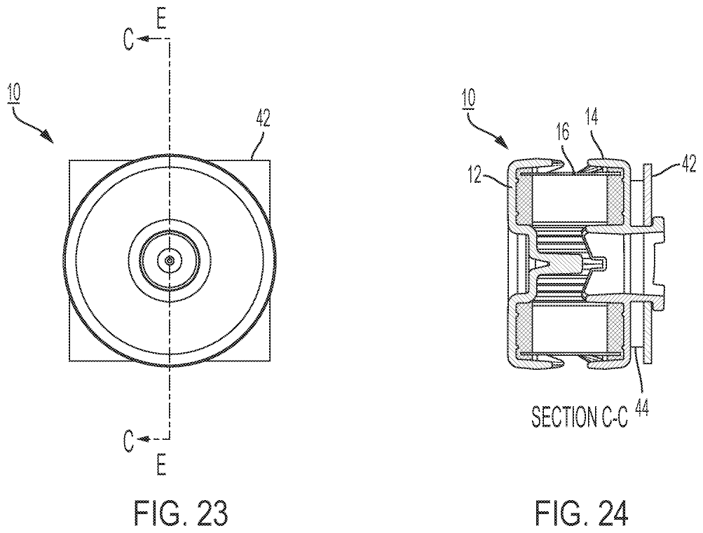

Another embodiment of the filter cartridge 10 is shown in FIGS. 21-24, similar to that described above with respect to FIGS. 17-20, but mounted to a base plate 42 utilizing a flat gasket 44.

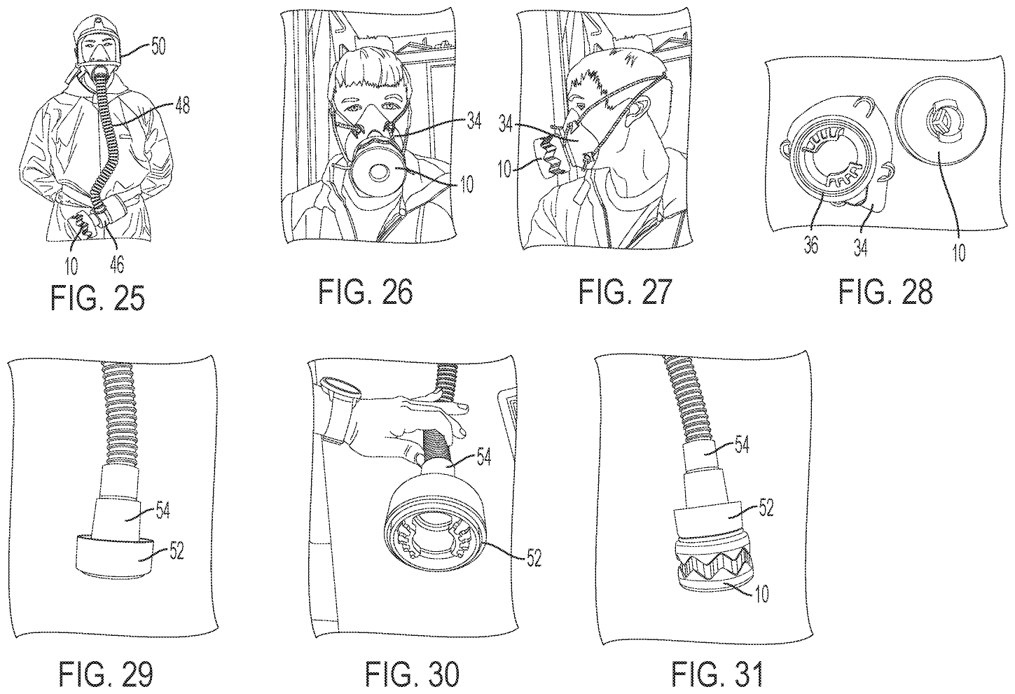

FIG. 25 illustrates a person wearing a powered air purification device 46 that incorporates the one embodiment of a filter cartridge 10, wherein air exchange occurs through a hose 48 and a full-facemask 50.

FIGS. 26 and 27 illustrates a person wearing a facemask 34 and one embodiment of the filter cartridge 10.

FIG. 27 is a side view of a person wearing a facemask incorporating one embodiment of a filter cartridge.

FIG. 28 is a plan view of a facemask 34, O-ring 36, and one embodiment of a detached filter cartridge 10 arranged side-by-side.

FIGS. 29-31 illustrates another embodiment of a base that may be used with the embodiments of a filter cartridge 10 as described herein. In this case, the base comprises a hose connection 52 that attaches to hose 54. The hose 54 may be connected to a variety of other air handling equipment, including facemasks, powered air purification devices, ventilators, etc.

As noted, it is beneficial to clean, replenish or otherwise restore filter media to extend the life of the filter cartridge describe herein. Options include without limitation washing with water and soap, sterilizing (such as in autoclave or with EtO or other suitable substance or process), or disinfecting.

Benefits of the described filter cartridge include, without limitation:
protection of the filter media when the filter cartridge is handled, such as when a facemask or other base is being donned, doffed, or used, when the filter cartridge is being mounted to or removed from the base, when the filter cartridge is being shipped and stored, when the filter cartridge is cleaned, sterilized, and/or disinfected, etc.;
when incorporating a washable or otherwise replenishable filter media, protection of the filter media during washing, sterilization, or other action to replenish the filter media;
more open exposure of the filter media in use, allowing for more effective air flow through the filter media over other device designs that may require screens or other coverings to protect the filter media;
simplicity in construction and assembly, with fewer parts and the ability to effectively assemble the filter cartridge with only the use of adhesive in each end cap holding the cartridge together;
Projections around the sides of the filter cartridge maximize airflow through the filter media, while reducing the space that is available for users to extend their fingers through the outer shell and grab the filter media while torqueing it. This protects the filter media from handling while eliminating the need for an extra screen placed around the filter media, which simplifies the part count;
Center tri-lobe core provides good airflow through the core of the cartridge and transmits torque from the cap to the base to minimize force on the filter media. This is a molded-in feature on both sides that does not need to be glued to transmit the torque from one cap to the other. This is commonly accomplished by using a separate cylindrical “core” component, but this approach eliminates the need for that component altogether, instead integrating that feature into the single molded part of the end cap;
Bayonet lock design accommodates a range of O-ring sizes as well as flat circular gaskets to seal the cartridge to the mating part. The simple flat design of the mating feature is flexible in how it can seal, and the relative motion of the cartridge to the mating piece while the bayonet is tightened is large enough to seal somewhat uneven surfaces (total travel motion is approximately 1.5 mm of relative movement between the parts as the bayonet is tightened);
Simple 2-lobe bayonet design for base attachment enables engagement to more complex molded or 3D printed parts, while still allowing for sealing against something as simple as a flat plate with a cutout of a specific geometry. This allows for many different sealing options depending on the manufacturing method of the mating part (machined, injection molded, 3D printed, vacuum formed, etc.).

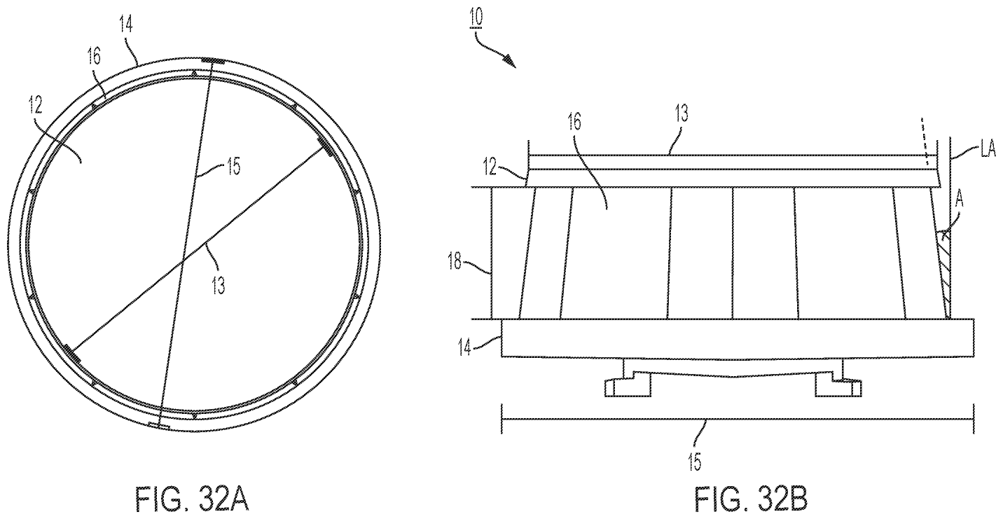

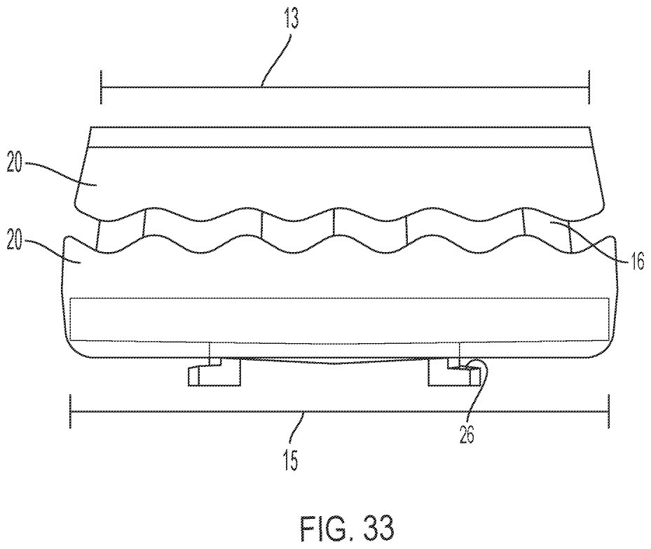

Referring to FIGS. 32A and 32B, an embodiment of the filter cartridge 10 is illustrated including a tapered or frustoconical profile. The filter cartridge 10 includes the top end component 12 (i.e., first end component) and the bottom end component 14 (i.e., second end component). The top end component 12 includes a first diameter 13 and the bottom end component 14 has a second diameter 15 that is greater than the first diameter 13. The filter media 16 is mounted between the two end components 12, 14 such that the outer diameter decreases toward the top end component 12. As illustrated in FIG. 32, the gap 18 is provided between the two end components 12, 14 of sufficient dimensions to allow free airflow through the filter media 16. The end components 12, 14 may also include projections 20 as illustrated in FIG. 33. The projections 20 are operable for the same functions and purposes as previously described herein. The projections 20 may be formed to be angled so as to conform to or match a similar profile of the filter media 16 in the tapered configuration. This limits the projections 20 from interfering with or otherwise contacting the filter media 16 which can result in increased wear in some embodiments. Accordingly, the projections 20 may be flared outwardly and inwardly on the top and bottom end components 12, 14, respectively.

In some embodiments, the filter media 16 is positioned between the two end components 12, 14 to form the tapered profile such that the diameter of the filter media 16 decreases along the longitudinal length toward the top end component 12. The pleats of the filter media 16 be positioned more tightly proximal to the top end component 12 relative to the pleats proximal to the bottom end component 14. The tapered profile of the filter media 16 may form an angle A that is from about five (5) degrees to about thirty (30) degrees relative to a longitudinal axis LA. For example, in one embodiment, the filter media 16 is positioned to form an angle A that is fifteen (15) degrees relative to the longitudinal axis. The relative angle A between the filter media 16 and the longitudinal axis LA may be five (5), ten (10), fifteen (15), twenty (20), twenty-five (25), or thirty (30) degrees.

The filter media 16 is positioned with the end components 12, 14 to form a fluid tight seal such that fluid flows through the filter media 16 and not between the filter media 16 and the end components 12, 14. Because the filter media 16 an angle relative to the longitudinal axis, the ends of the filter media 16 received by the end components 12, 14 and the filter media 16 may be modified to provide a secure seal between the filter media 16 and the end components 12, 14. For example, sufficient adhesive or potting material may be applied between the filter media 16 and the end components 12, 14 to secure the filter media 16 and the end components 12, 14 to each other and to fill any gaps between the filter media 16 and the end components 12, 14.

In some embodiments, the receiving surface of the end components 12, 14 may be angled to accommodate any angles formed at the longitudinal ends of the filter media 16 by positioning the filter media 16 in the tapered configuration. In some embodiments, the longitudinal ends of the filter media 16 may be formed or cut to terminate in planes when the filter media 16 is positioned in the tapered configuration. As illustrated, the filter cartridge 10 further includes the interface 26 such that the filter cartridge 10 can interface with other components such as facemasks and the like.

Several advantages may be realized by providing a filter cartridge 10 with a tapered profile. Some of those advantages include, but are not limited to, reduction of weight of the top end component 12, decreased profile of the filter cartridge, decreased longitudinal length of the filter cartridge 10, and increased surface are of the filter media 16 relative to the radial profile and longitudinal length. For example, when the filter cartridge 10 is mounted to a facemask (e.g., facemask 34, full-facemask 50, and so forth), the decreased outer profile provided by the tapering and length of the filter cartridge 10 relative to the untampered embodiments with the same surface area of filter media 16 provides increased visibility for the viewing filed beyond the filter cartridge 10. Furthermore, the reduced longitudinal length and mass of the top end component 12 reduces the moment arm and consequently torque applied by the filter cartridge 10 on the facemask when mounted thereto. This also allows for the filter cartridge 10 to be placed in different positions for enhanced flow paths, visibility, and so forth.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents

What is claimed is:

1. A filter cartridge comprising:
a first end component, a second end component, and a filter media positioned between the first end component and the second end component, the filter media maintaining separation between the first end component and the second end component to allow for air flow through the filter media;
wherein the first end component includes at least two receptors and the second end component includes at least one protrusion configured to interface with the at least two receptors to hold the first end component and the second end component in the same relative position with respect to each other when a torque is applied to the filter cartridge;
wherein the cartridge is assembled together by adhesive binding the filter media to the first end component and the second end component.

2. The filter cartridge of claim 1, wherein the first end component includes at least 3 slots and the second end component includes at least 3 corresponding protrusions.

3. The filter cartridge of claim 1, wherein the first end component and the second end component include a series of projections that partially cover the filter media to protect the filter media from damage when the filter cartridge is handled.

4. The filter cartridge of claim 3, wherein the projections comprise an undulating pattern.

5. The filter cartridge of claim 1, wherein the cartridge is assembled together with only the adhesive binding the filter media to the first end component and the second end component.

6. The filter cartridge of claim 1, wherein a fitting is included on at least one of the first and second end components to allow the filter cartridge to be attached onto a base.

7. The filter cartridge of claim 6, wherein the fitting is configured to allow the filter cartridge to be attached to the base by twisting.

8. The filter cartridge of claim 6, wherein the base comprises a facemask.

9. The filter cartridge of claim 6, wherein the base comprises an interface with a hose.

10. The filter cartridge of claim 9, wherein the hose attaches to a powered air purification device.

11. The filter cartridge of claim 9, wherein the hose attaches to a ventilator device.

12. The filter cartridge of claim 6, wherein the base comprises an interface with a flat plate with a cutout.

13. The filter cartridge of claim 6, wherein one of the first and second end component including the fitting includes a gasket interface.

14. The filter cartridge of claim 13, wherein the gasket interface comprises a groove configured to receive an O-ring gasket to seal between the filter cartridge and the base.

15. The filter cartridge of claim 13, wherein the gasket interface comprises a circular flat gasket attached to one of the first and second end components.

16. A filter cartridge that comprises
a first end component, a second end component, and a filter media positioned between the first end component and the second end component, the filter media maintaining separation between the first end component and the second end component to allow for air flow through the filter media;
wherein the first end component and the second end component include a series of projections that partially cover the filter media to protect the filter media from damage when the filter cartridge is handled.

17. The filter cartridge of claim 16, wherein the projections comprise an undulating pattern.

18. The filter cartridge of claim 16, wherein the first end component includes at least two slots and the second end component includes at least one protrusion configured to interface with the at least two slots to hold the first end component and the second end component in the same relative position with respect to each other when a torque is applied to the filter cartridge.

19. The filter cartridge of claim 18, wherein the first end component includes at least 3 slots and the second end component includes at least 3 corresponding protrusions.

20. The filter cartridge of claim 16, wherein a fitting is included on at least one of the end components to allow the filter cartridge to be attached onto a base.

21. The filter cartridge of claim 20, wherein the base comprises a facemask.

22. A filter cartridge comprising:
a first end component, a second end component, and filter media positioned between the first end component and the second end component, the filter media maintaining separation between the first end component and the second end component to allow for air flow through the filter media;
wherein the first end component includes at least one protrusion configured to interface with second end component to resist compression of the first end component towards the second end component other during use;
wherein the cartridge is assembled together by adhesive binding the filter media to the first end component and the second end component.

23. A filter cartridge for mounting to a facemask, the filter cartridge comprising:
a first end component having a first diameter;
a second end component having a second end diameter that is greater than the first diameter; and
a filter media positioned between the first end component and the second end component, the filter media maintaining separation between the first end component and the second end component to allow for air flow through the filter media, the filter media having a tapered outer profile from the first end component toward the second end component.
